(19) United States
(12) Patent Application Publication
(10) Pub. No.: US 2015/0196043 A1
(43) Pub. Date: Jul. 16, 2015

(54) GREEN TEA BEVERAGE PACKED IN CONTAINER AND METHOD OF MANUFACTURING SAME

(71) Applicant: ITO EN, LTD., Tokyo (JP)

(72) Inventors: Masami Sasame, Shizuoka (JP); Kazuto Murayama, Tokyo (JP); Yohsuke Fujii, Shizuoka (JP); Masataka Sakata, Shizuoka (JP)

(73) Assignee: ITO EN, LTD., Tokyo (JP)

(21) Appl. No.: 14/387,376

(22) PCT Filed: Oct. 1, 2013
(86) PCT No.: PCT/JP2013/076632

§ 371 Date: Sep. 23, 2014

(30) Foreign Application Priority Data
Oct. 1, 2012 (JP) 2012-219688

(51) Int. Cl. A23F 3/16

(52) U.S. Cl. CPC A23F 3/16

(57) ABSTRACT

There has been a need to provide a green tea beverage packed in a container which exhibits a smooth feeling in the throat and a lingering taste when the beverage is drunk cold, in particular even when time has passed since the container was opened and the beverage temperature has increased and become lukewarm. The present invention provides a green tea beverage packed in a container which exhibits a smooth feeling in the throat and a lingering taste when the beverage is drunk cold, in particular even when time has passed since the container was opened and the beverage temperature has increased and become lukewarm, by adjusting a particle diameter of cumulative 90 mass % (D90) in a tea extracted liquid to 3 μm to 60 μm and adjusting a sugar/tartness degree ratio to 0.12 to 0.43.

### TECHNICAL FIELD

The present invention relates to a green tea beverage packed in a container which exhibits a smooth feeling in the throat and a lingering taste when the beverage is drunk cold, in particular even when time has passed since the container was opened and the beverage temperature has increased and become lukewarm. The present invention also relates to a method of manufacturing the same and a method of maintaining a flavor of a green tea beverage.

### BACKGROUND ART

Different from the conventional drinking style for green tea using a teapot to make tea, a so-called green tea beverage packed in a container has widely become common. A green tea beverage packed in a container is obtained by filling a container with a green tea extracted liquid, and can readily be drunk.

This has raised a variety of consumer needs for a green tea beverage packed in a container. There are also various drinking scenes for a green tea beverage packed in a container. Rather than drinking hot tea supposed in a case of using a teapot to make green tea, opportunities of directly drinking a refrigerated beverage are increasing and are well-received particularly in hot summer.

Different from the conventional green tea extracted liquid to be drunk hot, a green tea beverage packed in a container to be drunk cold has excellent thirst-quenching ability, but a smooth feeling in the throat and a lingering taste which are possessed originally by the green tea may be weakly felt. Among other things, an aroma felt when the tea beverage is kept in the mouth, lingering taste, thickness, deliciousness and feeling in the throat may not be felt enough.

In particular, since the taste and aroma of a green tea beverage are delicate, there have been considerably high technical hurdles in designing a green tea beverage packed in a container to be drunk cold so that the taste and aroma possessed originally by the green tea can be felt enough, especially compared with other beverages packed in containers.

Besides the technical problems specific to a green tea beverage packed in a container as described above, there have been increasing scenes not seen before in which a cold green tea beverage packed in a container is drunk in small amounts for a long period of time during work, such as job and study, in particular among young people (so-called “slow sipping” (“Chibidaranomi”)). In such drinking scenes, the cold green tea beverage packed in a container becomes lukewarm little by little as time passes, and such a temperature change will deteriorate the aroma felt in the mouth, lingering taste, thickness, deliciousness and feeling in the throat, which are possessed originally by the green tea beverage, thereby to newly lead to another technical problem in that the balance as a whole may become poor.

To solve the technical problems specific to the variety of drinking scenes and to the green tea, various approaches are performed. For example, Patent Literature 1 discloses a green tea beverage which has strong fire aroma (savory aroma) and has no light taste, and yet gives refreshing aftertaste, and can be drunk delectably even in a cold state. The green tea beverage thus provided is a green tea beverage packed in a container wherein the concentration of sugars, i.e., the sum of the concentration of monosaccharide and the concentration of disaccharide, is 100 ppm to 300 ppm, and the ratio of the concentration of disaccharide relative to the concentration of monosaccharide (disaccharide/monosaccharide) is 10 to 28.

Patent Literature 2 discloses a new green tea beverage, packed in a container, which has spreading aroma in the mouth, afterglow of aroma, and yet has richness and/or concentration feeling in the taste and has aroma note even in a cold state. This green tea beverage packed in a container is provided such that: the concentration of sugars, which is the sum of monosaccharide and disaccharide, is 150 ppm to 500 ppm; the ratio of the concentration of disaccharide relative to the concentration of monosaccharide (disaccharide/monosaccharide) is 2.0 to 8.0; the ratio of the concentration of electron-localized catechin relative to the above-mentioned concentration of sugars (electron-localized catechin/sugars) is 1.8 to 4.0; and the content ratio of furfural relative to geraniol (furfural/geraniol) is 0.5 to 3.0.

However, what are disclosed in Patent Literature 1 and Patent Literature 2 are not those researched under an object to provide a green tea beverage packed in a container which exhibits a smooth feeling in the throat and a lingering taste when the beverage is drunk cold, in particular even when time has passed since the container was opened and the beverage temperature has increased and become lukewarm. Also in other patent literature, there is not recognized any technical issue of developing a green tea beverage packed in a container which has such properties. Furthermore, there has been almost no specific proposal for a method to solve such technical issues.

### [Patent Literature 1] Japan Patent No. 4843118

### [Patent Literature 2] Japan Patent No. 4843119

### DISCLOSURE OF THE INVENTION

### Problems to be Solved by the Invention

An object of the present invention is to provide a green tea beverage packed in a container which exhibits a smooth feeling in the throat and a lingering taste when the beverage is drunk cold, in particular even when time has passed since the container was opened and the beverage temperature has increased and become lukewarm, which technical problem would not exist heretofore, while taking advantage of the above knowledge of Prior Art Literature. Another object of the present invention is to provide a method of manufacturing the same.

### Means for Solving the Problems

As a result of intensive studies to focus on the relationship between a particle diameter of cumulative 90 mass % (D90) in a tea extracted liquid and a sugar/tartness degree ratio, the present inventors have found that the above technical problems can be solved by adjusting the particle diameter of cumulative 90 mass % (D90) in the tea extracted liquid to 3 μm to 60 μm and adjusting the sugar/tartness degree ratio to 0.12 to 0.43, and have thus achieved the present invention.

That is, the present invention relates to:

(1) A green tea beverage packed in a container, characterized in that: a particle diameter of cumulative 90 mass % (D90) in a tea extracted liquid is 3 μm to 60 μm; and a sugar/tartness degree ratio is 0.12 to 0.43;

(2) The green tea beverage packed in a container as described in (1), characterized in that a concentration of sugars, which is a sum of a concentration of monosaccharide and a concentration of disaccharide, is 87 ppm to 380 ppm;

(3) The green tea beverage packed in a container as described in (1) or (2), characterized in that a weight ratio of a concentration of disaccharide to a concentration of sugars, which is a sum of a concentration of monosaccharide and the concentration of disaccharide, is 0.69 to 0.92;

(4) The green tea beverage packed in a container as described in any one of (1) to (3), characterized in that a total value of a tartness degree is 600 ppm to 840 ppm;

(5) The green tea beverage packed in a container as described in any one of (1) to (4), characterized in that a concentration of electron-localized catechin is 250 ppm to 550 ppm;

(6) The green tea beverage packed in a container as described in any one of (1) to (5), characterized in that a concentration of caffeine is less than 200 ppm;

(7) The green tea beverage packed in a container as described in any one of (1) to (6), characterized in that the green tea beverage contains particles having an average particle diameter of 1 μm or more;

(8) The green tea beverage packed in a container as described in any one of (1) to (7), characterized in that a degree of transparency is 4 to 12;

(9) A method of manufacturing a green tea beverage packed in a container, the method being characterized by comprising: adjusting a particle diameter of cumulative 90 mass % (D90) in a tea extracted liquid to 3 μm to 60 μm; and adjusting a sugar/tartness degree ratio to 0.12 to 0.43; and

(10) A method of improving a taste of a green tea beverage, the method being characterized by comprising: adjusting a particle diameter of cumulative 90 mass % (D90) in a tea extracted liquid to 3 μm to 60 μm; and adjusting a sugar/tartness degree ratio to 0.12 to 0.43.

### Advantageous Effect of the Invention

According to the present invention, there can be obtained a green tea beverage packed in a container which exhibits a smooth feeling in the throat and a lingering taste when the beverage is drunk cold, in particular even when time has passed since the container was opened and the beverage temperature has increased and become lukewarm.

### BEST MODE FOR CARRYING OUT THE INVENTION

The green tea beverage packed in a container according to the present invention is characterized in that: a particle diameter of cumulative 90 mass % (D90) in a tea extracted liquid is 3 μm to 60 μm; and a sugar/tartness degree ratio is 0.12 to 0.43.

### MODE FOR CARRYING OUT THE INVENTION

The green tea beverage packed in a container according to the present invention may be a beverage obtained by filling a container with a liquid that contains, as a main component, an extracted liquid obtained by extracting green tea. Examples of the liquid include a liquid that consists only of an extracted liquid obtained by extracting green tea, a liquid obtained by diluting the extracted liquid, a liquid obtained by mixing the extracted liquids with each other, a liquid obtained by adding an additive to any of the above liquids, and a liquid obtained by dispersing those dried of any of the above liquids.

The “main component” as used herein encompasses a meaning that accepts other components to be contained to such an extent that the functionality of the main component is not hindered. Here, the content ratio of the main component is not specified, but the extracted liquid or extracted material obtained by extracting green tea may preferably take up 50 mass % or more, particularly preferably 70 mass % or more, and further particularly preferably 80 mass % or more (including 100%) in the beverage as the concentration of a solid content.

### (Raw Materials of Tea Leaves)

Raw tea leaves for the green tea beverage in the present invention are not particularly limited in the types of green teas. For example, the types of green teas may broadly encompass teas that are classified as non-fermented tea, such as steamed tea (“Mushicha”), decocted tea (“Sencha”), refined green tea (“Gyokuro”), powdered green tea (“Maccha”), coarse tea (“Bancha”), curly green tea (“Tamaryokucha”), oven-roasted tea (“Kamairicha”) and Chinese green tea, and may also encompass those blended in two or more types thereof. In addition, cereals such as brown rice, flavors such as jasmine and other appropriate additives may be added thereto.

### (Particle Diameter of Cumulative 90 Mass % (D90))

The particle diameter of cumulative 90 mass % (D90) in the green tea beverage according to the present invention is preferably 3 μm to 60 μm, more preferably 3 μm to 50 μM, further preferably 3 μm to 40 μm, and most preferably 3 μm to 30 μm. If the particle diameter of cumulative 90 mass % (D90) in the green tea beverage is adjusted within the above range, and other factors to be adjusted, such as the sugar/tartness degree ratio, are appropriately adjusted, then the green tea beverage can have both the rich thickness and sweet taste due to texture felt on the tongue even when the green tea beverage is drunk cold.

The particle diameter of cumulative 90 mass % (D90) in the green tea beverage can be adjusted within the above range such as by subjecting the raw material to a drying (heating (“Hiire”)) process and by filtrating the extracted liquid. Examples of such filtration include ultrafiltration, fine filtration, microfiltration, reverse osmosis membrane filtration, electrodialysis, membrane filtration using a biofunction-membrane, and cake filtration using a porous medium. Among them, the cake filtration may preferably be employed for the adjustment in view of the productivity and adjusting the particle diameter. In the cake filtration, either one or both of a filtration agent that contains a large amount of silica and a porous medium such as diatom earth may be used.

The particle diameter of cumulative 90 mass % (D90) in the green tea beverage can be measured by using a commercially available laser diffraction-type particle diameter distribution measuring apparatus or other appropriate apparatus, for example.

### (Sugar/Tartness Degree Ratio)

The “sugar/tartness degree ratio” as referred to in the present invention may be represented by the ratio of the concentration of sugars (concentration of monosaccharide +concentration of disaccharide (ppm)) to the tartness degree as follows:

Sugar/tartness degree ratio=Concentration of sugars (ppm)/Tartness degree (ppm)

The “tartness degree” as used herein is a value obtained by adding an acid degree (ppm) of the concentration of vitamin C (ppm) in citric acid equivalent to the fraction of tannin which is a component of astringent taste, and may be represented by the following equation:

Tartness degree (ppm)=Amount of vitamin C (ppm)×0.365+Amount of tannin (ppm)

The sugar/tartness degree ratio in the green tea beverage according to the present invention is preferably 0.12 to 0.43, more preferably 0.13 to 0.39, further preferably 0.14 to 0.37, and most preferably 0.15 to 0.35. If the sugar/tartness degree ratio in the green tea beverage is adjusted within the above range, and other factors to be adjusted, such as the particle diameter of cumulative 90 mass % (D90), are appropriately adjusted, then the green tea beverage can have both the rich thickness and sweet taste due to texture felt on the tongue even when the green tea beverage is drunk cold.

The sugar/tartness degree ratio in the green tea beverage can be adjusted within the above range such as by selecting the type of raw tea, the tea-picking season (“Chaki”) and the production area, and by adjusting the conditions for extraction and the amount of adding vitamin C, in addition to by the processing method for the raw tea, the filtrating method for the extracted liquid and the like as described above.

The tartness degree of the green tea beverage according to the present invention is not particularly limited, but may preferably be 600 ppm to 840 ppm.

The concentration of sugars can be adjusted within the above range by employing appropriate conditions for the drying (heating) process for the tea leaves and extraction. For example, when the drying (heating) process for the tea leaves is performed in an enhanced manner, the sugars are decomposed to decrease, and when the extraction is performed at a high temperature for a long time, the sugars are also decomposed to decrease. Thus, the concentration of sugars can be adjusted by the conditions for the drying (heating) process for the tea leaves and the conditions for extraction.

Here, the adjustment can be possible by adding sugars, but in this case there may be a risk that the flavor balance possessed originally by the green tea beverage will be disrupted. Therefore, the adjustment may preferably be performed without adding sugars, such as by adjusting conditions for obtaining a tea extracted liquid as well as by mixing tea extracted liquids with each other or by adding a tea extracted material.

The amount of tannin can be increased by increasing the compounding ratio of raw tea leaves of which the tea-picking season is late (e.g., “Environmental Variation of the Chemical Constituents of the Tea Leaf (Part 2)”, Journal of Agricultural Chemical Society of Japan (“Nippon Nogeikagaku kaishi”), Vol. 27), for example. The amount of tannin can be adjusted by adjusting the conditions for extraction when obtaining the tea extracted liquid and/or the mixing ratio of the obtained plural types of extracted liquids.

Here, the adjustment can be possible by separately adding tannin, but in this case there may be a risk that the flavor balance possessed originally by the green tea beverage will be disrupted. Therefore, the adjustment may preferably be performed without adding tannin, such as by adjusting conditions for obtaining a tea extracted liquid as well as by mixing tea extracted liquids with each other or by adding a tea extracted material.

The vitamin C can be adjusted in consideration of the amount of vitamin C in the raw tea leaves as well as in consideration of the amount of vitamin C to be added to the green tea beverage.

### (Monosaccharide)

The monosaccharide is a carbohydrate substance represented by a general formula C₆(H₂O)₆, and is not to be hydrolyzed any more to further simple sugar. The monosaccharide as referred to in the present invention represents glucose (grape sugar) or fructose (fruit sugar).

The concentration of monosaccharide in the green tea beverage according to the present invention may preferably be 7 to 120 ppm, more preferably 11 to 100 ppm, further preferably 15 to 80 ppm, and most preferably 18 to 70 ppm. If the concentration of monosaccharide in the green tea beverage packed in a container is less than 7 ppm, the thickness in the green tea beverage will be insufficient, thus being undesirable. If the concentration of monosaccharide in the green tea beverage packed in a container is more than 120 ppm, the aroma felt in the mouth will be weak, thus being undesirable.

### (Disaccharide)

The disaccharide is a carbohydrate substance represented by a general formula C₁₂(H₂O)₁₁, and is to be hydrolyzed to provide a monosaccharide. The disaccharide as referred to in the present invention represents sucrose (cane sugar), cellobiose or maltose (malt sugar).

The concentration of disaccharide in the green tea beverage according to the present invention may preferably be 80 ppm to 260 ppm, more preferably 80 ppm to 230 ppm, further preferably 90 ppm to 200 ppm, and most preferably 90 ppm to 180 ppm.

### (Concentration of Sugars)

The “concentration of sugars being a sum of a concentration of monosaccharide and a concentration of disaccharide” as referred to in the present invention is to be obtained by summing up the concentration of the above monosaccharide and the concentration of the above disaccharide.

The “concentration of sugars being a sum of a concentration of monosaccharide and a concentration of disaccharide” in the green tea beverage according to the present invention may preferably be 87 ppm to 380 ppm, more preferably 91 ppm to 320 ppm, further preferably 105 ppm to 280 ppm, and most preferably 108 ppm to 250 ppm.

### (Concentration of Catechins)

The concentration of catechins in the green tea beverage according to the present invention may preferably be 280 ppm to 600 ppm, more preferably 290 ppm to 580 ppm, further preferably 310 ppm to 550 ppm, and most preferably 330 ppm to 500 ppm. If the concentration of catechins in the green tea beverage packed in a container is less than 280 ppm, the sweet fire aroma may be enhanced, but the balance will be affected such as due to unduly weak fresh aroma and insufficient concentration feeling, thus being undesirable. If the concentration of catechins in the green tea beverage packed in a container is more than 600 ppm, the fresh aroma may be enhanced, but the balance will be affected such that the sweet fire aroma will be unduly weakened and the bitter and astringent taste and the harsh taste may be unduly enhanced, thus being undesirable.

Here, the total catechins mean total 8 types of catechin (C), gallocatechin (GC), catechin gallate (Cg), gallocatechin gallate (GCg), epicatechin (EC), epigallocatechin (EGC), epicatechin gallate (ECg) and epigallocatechin gallate (EGCg), and the concentration of the total catechins means the total value of the concentrations of the 8 type catechins.

The concentration of the total catechins may be adjusted within the above range by adjusting the conditions for extraction. Here, the adjustment can be possible by adding catechins, but in this case there may be a risk that the balance of the green tea beverage will be disrupted. Therefore, the adjustment may preferably be performed such as by adjusting conditions for obtaining a tea extracted liquid as well as by mixing tea extracted liquids with each other or by adding a tea extracted material.

### (Epimeric Catechins/Non-Epimeric Catechins)

The catechins in the green tea beverage according to the present invention may contain “epimeric catechins”, i.e., (−) EC, (−) EGC, (−) ECg and (−) EGCg, and may contain “non-epimeric catechins”, i.e., (−) C, (−) GC, (−) Cg and (−) GCg. The “non-epimeric catechins” can be obtained by performing heat treatment at a temperature of about 80° C. or more to facilitate thermal isomerization (epimerization). The “ratio of the non-epimeric catechins to the epimeric catechins (non-epimeric catechins/epimeric catechins)” in the green tea beverage according to the present invention may preferably be 0.4 to 10.0, further preferably 0.5 to 3.0, and most preferably 0.6 to 1.5.

### (Concentration of Electron-Localized Catechin)

The concentration of electron-localized catechin in the green tea beverage according to the present invention may preferably be 250 ppm to 550 ppm, more preferably 260 ppm to 530 ppm, further preferably 280 ppm to 500 ppm, and most preferably 300 ppm to 450 ppm.

The “electron-localized catechin” as referred to in the present invention is a catechin that has a triol structure (a structure having 3 OH groups adjacent to the benzene ring) and is considered to be likely to cause localization of the electric charge when ionized. Specific examples thereof include epigallocatechin gallate (EGCg), epigallocatechin (EGC), epicatechin gallate (ECg), gallocatechin gallate (GCg), gallocatechin (GC), and catechin gallate (Cg).

The concentration of the electron-localized catechin may be adjusted within the above range by adjusting the conditions for extraction, but an unduly high temperature and an unduly long extraction time may be undesirable from an aspect of maintaining the aroma of the beverage because the concentration of the electron-localized catechin may readily change depending on the extraction time and the temperature. Here, the adjustment can be possible by adding the electron-localized catechin, but in this case there may be a risk that the balance of the green tea beverage will be disrupted. Therefore, the adjustment may preferably be performed such as by adjusting conditions for obtaining a tea extracted liquid as well as by mixing tea extracted liquids with each other or by adding a tea extracted material.

### (Ratio of Concentration of Electron-Localized Catechin to Concentration of Sugars (Electron-Localized Catechin/Sugars))

The “ratio of the concentration of the electron-localized catechin to the concentration of the sugars (electron-localized catechin/sugars)” in the green tea beverage according to the present invention may preferably be 1.6 to 3.4, more preferably 1.8 to 3.2, and further preferably 2.0 to 3.0.

The ratio of the concentration of the electron-localized catechin to the concentration of the sugars may be adjusted within the above range by adjusting the conditions for extraction, but the extraction time may preferably be short because the extraction rate of catechin is high at a high temperature while the high temperature state causes the sugars to readily decompose. Here, the adjustment can be possible by adding the electron-localized catechin and the sugars, but in this case there may be a risk that the balance of the green tea beverage will be disrupted. Therefore, the adjustment may preferably be performed such as by adjusting conditions for obtaining a tea extracted liquid as well as by mixing tea extracted liquids with each other or by adding a tea extracted material.

### (Concentration of Caffeine)

The concentration of caffeine in the green tea beverage according to the present invention may preferably be less than 200 ppm, more preferably 0 ppm to 150 ppm, further preferably 0 ppm to 120 ppm, still further preferably 0 ppm to 100 ppm, yet further preferably 0 ppm to 40 ppm, and most preferably 0 ppm to 30 ppm. If the concentration of caffeine in the green tea beverage packed in a container is more than 200 ppm, the bitter taste originated from caffeine will affect the balance between the feeling of aroma and the bitter taste, thus being undesirable.

The concentration of caffeine may be adjusted within the above range through: dissolving caffeine in the tea leaves into water such as by spraying hot water to the tea leaves and by immersing the tea leaves in hot water; using the tea leaves to produce tea extracted liquids; and mixing the tea extracted liquids with each other. The caffeine may also be adsorbed to be removed by causing an adsorbent such as active carbon and white clay to act with the extracted liquid.

### (Ratio of Concentration of Total Catechins to Concentration of Caffeine (Total Catechins/Caffeine))

The “ratio of the concentration of total catechins to the concentration of caffeine (total catechins/caffeine)” in the present invention may preferably be 1.4 to 600, more preferably 2.0 to 350, and most preferably 4.0 to 200. If the ratio of the concentration of total catechins to the concentration of caffeine (total catechins/caffeine) in the green tea beverage packed in a container is less than 1.4, the bitter taste will be excessively remarkable relative to the thickness/concentration feeling to disrupt the balance, thus being undesirable. If the ratio of the concentration of total catechins to the concentration of caffeine (total catechins/caffeine) in the green tea beverage packed in a container is more than 660, the astringent taste will be excessively remarkable relative to the thickness/concentration feeling to disrupt the balance, thus being undesirable.

The ratio of the concentration of total catechins to the concentration of caffeine can be adjusted within the above range by the caffeine reducing process as described above or adjusting the amount of the tea leaves and the extraction temperature. The adjustment can also be possible by adding the total catechins, but in this case there may be a risk that the balance of the green tea beverage will be disrupted. Therefore, the adjustment may preferably be performed such as by adjusting conditions for obtaining a tea extracted liquid as well as by mixing tea extracted liquids with each other or by adding a tea extracted material.

### (Degree of Transparency)

The degree of transparency as referred to in the present invention is an indicator that is indicative of a degree of turbidity of water color in the green tea beverage. The degree of transparency in the green tea beverage according to the present invention may preferably be 4 to 12. The degree of transparency in the present invention is to be measured in conformity with the method of JIS (Japanese Industrial Standards) K0102-9. Specifically, the degree of transparency can be measured through: filling a transparency meter with a sample liquid, wherein the transparency meter is a glass cylinder that has a lower opening and is provided with scale marks at every 10 mm and also provided with a marker plate marked with double-cross lines at the bottom of the glass cylinder; seeing through from the top to the bottom; and reading a scale mark when the double-cross mark lines of the marker plate can first be recognized obviously while draining the sample from the lower opening in a rapid manner. In the present invention, the above procedure may be repeated twice to obtain an average, and the average is to represent a degree of transparency (1 degree corresponds to 10 mm).

(pH)

The pH of the green tea beverage according to the present invention may preferably be 6.0 to 6.5 at 20° C. The pH of the present green tea beverage packed in a container may more preferably be 6.0 to 6.4, and particularly further preferably 6.1 to 6.3.

### (Method of Measuring Each Component)

A calibration curve method such as using high-performance liquid chromatogram (HPLC) or other appropriate method may be employed to measure the concentrations of the above catechins, electron-localized catechins and caffeine.

### (Container)

A container to be filled with the green tea beverage according to the present invention is not particularly limited. For example, a plastic-made bottle (so-called PET bottle), a can of a metal such as steel and aluminum, a bottle, a paper container and the like may be used. In particular, a transparent container or the like, such as a PET bottle, may preferably be used as the container.

### (Manufacturing Method)

The green tea beverage according to the present invention can be manufactured, for example, by selecting raw materials of tea leaves and appropriately adjusting conditions for a drying (heating) process and extraction for the tea leaves, thereby to adjust the particle diameter of cumulative 90 mass % (D90) in the tea extracted liquid to 3 μm to 60 μm and adjust the sugar/tartness degree ratio to 0.12 to 0.43. For example, the present green tea beverage packed in a container can be manufactured through: preparing an extracted liquid that is obtained by subjecting tea leaves to a drying (heating) process at 250° C. to 260° C. and extracting the tea leaves at a high temperature for a short time; also preparing a conventional general green tea extracted liquid, i.e., an extracted liquid that is obtained by subjecting tea leaves to a drying (heating) process at 90° C. to 100° C. and extracting the tea leaves at a low temperature for a long time; and then blending them at an appropriate ratio. The present green tea beverage packed in a container can also be manufactured through subjecting an extracted liquid to a centrifugal separation process of which the conditions are appropriately adjusted. In an alternative embodiment, the present green tea beverage packed in a container may be manufactured through subjecting a turbid liquid of crushed tea leaves to a centrifugal separation process of which the conditions are appropriately adjusted and mixing the separated liquid with an extracted liquid at an appropriate ratio. Note, however, that the present invention is not limited to such manufacturing methods.

### Examples

Examples of the present invention will hereinafter be described, but the present invention is not limited to the examples as described below.

### (Green Tea Leaves Extracted Liquid A)

A green tea leaves extracted liquid A was obtained through: extracting 20 g of green tea leaves for extracted liquid (Yabukita species, autumn/winter coarse tea (“Bancha”) produced in Shizuoka Prefecture, dried tea leaves (“Aracha”)) with 700 mL of hot water (80° C.) for 6 minutes; thereafter processing the extracted liquid using a centrifugal separator (SA1 continuous centrifugal separator available from Westphalia) under the conditions of a flow rate of 300 L/hr, a rotation speed of 10000 rpm, and a centrifugal settling area (Σ) of 1000 m²; and diluting the liquid with water to 700 ml using a measuring cylinder.

### (Green Tea Leaves Extracted Liquid B)

A green tea leaves extracted liquid B was obtained through: extracting 14 g of green tea leaves for extracted liquid (Yabukita species, deeply steamed second-picked tea leaves produced in Shizuoka Prefecture, dried tea leaves (“Aracha”)), which were subjected to a heating process at 285° C. for 8 minutes using a rotative drum-type heating machine, with 700 mL of hot water (60° C.) for 6 minutes; thereafter processing the extracted liquid using a centrifugal separator (SA 1 continuous centrifugal separator available from Westphalia) under the conditions of a flow rate of 300 L/hr, a rotation speed of 10000 rpm, and a centrifugal settling area (E) of 1000 m²; and diluting the liquid with water to 700 ml using a measuring cylinder.

### (Crushed Tea Leaves C for Turbid Liquid)

Crushed tea leaves C for a turbid liquid were obtained by putting 200 kg of green tea leaves (Samidori species, first-picked tea leaves produced in Aichi Prefecture, powdered tea leaves (“Tencha”)) into a ball mill (BM-400 available from MAKINO Corporation) to crush them.

### (Crushed Tea Leaves D for Turbid Liquid)

Crushed tea leaves D for a turbid liquid were obtained by crushing green tea leaves (Samidori species, first-picked tea leaves produced in Aichi Prefecture, powdered tea leaves (“Tencha”)) using a jet mill (437-type available from NIPPON KANRYU INDUSTRY CO., LTD) under the conditions of a throughput of 10 kg/hr and a discharge pressure of 0.9 MPa.

### (Crushed Tea Leaves Turbid Liquid A)

A crushed tea leaves turbid liquid A was obtained through: dispersing 0.20 g of the crushed tea leaves C for turbid liquid in 300 mL of water using a high-speed homogenizer; performing self-weight filtration using a sieve for test (made of nylon) having a mesh opening of 80 μm; and diluting the filtrated liquid with water to 700 ml using a measuring cylinder. The degree of transparency of the crushed tea leaves turbid liquid A was 2.3.

### (Crushed Tea Leaves Turbid Liquid B)

A crushed tea leaves turbid liquid B was obtained through: dispersing 0.22 g of the crushed tea leaves C for turbid liquid in 300 mL of water using a high-speed homogenizer; performing self-weight filtration using a sieve for test (made of nylon) having a mesh opening of 60 μm; and diluting the filtrated liquid with water to 700 ml using a measuring cylinder. The degree of transparency of the crushed tea leaves turbid liquid B was 2.4.

### (Crushed Tea Leaves Turbid Liquid C)

A crushed tea leaves turbid liquid C was obtained through: dispersing 0.27 g of the crushed tea leaves C for turbid liquid in 300 mL of water using a high-speed homogenizer; performing self-weight filtration using a sieve for test (made of nylon) having a mesh opening of 40 μm; and diluting the filtrated liquid with water to 700 ml using a measuring cylinder. The degree of transparency of the crushed tea leaves turbid liquid C was 2.5.

### (Crushed Tea Leaves Turbid Liquid D)

A crushed tea leaves turbid liquid D was obtained through: dispersing 0.43 g of the crushed tea leaves C for turbid liquid in 300 mL of water using a high-speed homogenizer; performing self-weight filtration using a sieve for test (made of nylon) having a mesh opening of 30 μm; and diluting the filtrated liquid with water to 700 ml using a measuring cylinder. The degree of transparency of the crushed tea leaves turbid liquid D was 1.8.

### (Crushed Tea Leaves Turbid Liquid E)

A crushed tea leaves turbid liquid E was obtained through: dispersing 0.67 g of the crushed tea leaves D for turbid liquid in 300 mL of water using a high-speed homogenizer; performing self-weight filtration using a sieve for test (made of nylon) having a mesh opening of 5 μm; and diluting the filtrated liquid with water to 700 ml using a measuring cylinder. The degree of transparency of the crushed tea leaves turbid liquid E was 2.3.

### (Crushed Tea Leaves Turbid Liquid F)

A crushed tea leaves turbid liquid F was obtained through: dispersing 23 g of the crushed tea leaves D for turbid liquid in 300 mL of water using a high-speed homogenizer; performing self-weight filtration using a sieve for test (made of nylon) having a mesh opening of 2 μm; and diluting the filtrated liquid with water to 700 ml using a measuring cylinder. The degree of transparency of the crushed tea leaves turbid liquid F was 5.2.

### (Worked Product 1)

Compounding was performed using 700 ml of a mixture liquid of the green tea leaves extracted liquids A and B (compounding ratio (weight ratio) of green tea leaves extracted liquid A:green tea leaves extracted liquid B was 38:62) and 409 ml of a mixture liquid of the crushed tea leaves turbid liquids A and D (208 ml of the crushed tea leaves turbid liquid A and 201 ml of the crushed tea leaves turbid liquid D were mixed) (compounding was performed using the compounding amounts of the mixture liquid of the green tea leaves extracted liquids A and B and the mixture liquid of the crushed tea leaves turbid liquids A and D so that a target degree of transparency would be 6.0), and vitamin C was added thereto to be a final concentration of 31.1 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 1) was thereby obtained.

### (Worked Product 2)

Compounding was performed using 700 ml of a mixture liquid of the green tea leaves extracted liquids A and B (compounding ratio (weight ratio) of green tea leaves extracted liquid A:green tea leaves extracted liquid B was 3:97) and 365 ml of a mixture liquid of the crushed tea leaves turbid liquids A and F (83 ml of the crushed tea leaves turbid liquid A and 282 ml of the crushed tea leaves turbid liquid F were mixed) (compounding was performed using the compounding amounts of the mixture liquid of the green tea leaves extracted liquids A and B and the mixture liquid of the crushed tea leaves turbid liquids A and F so that a target degree of transparency would be 12.0), and vitamin C was added thereto to be a final concentration of 55.5 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 2) was thereby obtained.

### (Worked Product 3)

Compounding was performed using 700 ml of a mixture liquid of the green tea leaves extracted liquids A and B (compounding ratio (weight ratio) of green tea leaves extracted liquid A:green tea leaves extracted liquid B was 31:69) and 700 ml of the crushed tea leaves turbid liquid E (compounding was performed using the compounding amounts of the mixture liquid of the green tea leaves extracted liquids A and B and the crushed tea leaves turbid liquid E so that a target degree of transparency would be 6.0), and vitamin C was added thereto to be a final concentration of 42.2 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 3) was thereby obtained.

### (Worked Product 4)

Compounding was performed using 700 ml of a mixture liquid of the green tea leaves extracted liquids A and B (compounding ratio (weight ratio) of green tea leaves extracted liquid A:green tea leaves extracted liquid B was 5:95) and the crushed tea leaves turbid liquid E in a similar manner to that for Worked Product 3 so that a target degree of transparency would be 6.0, and vitamin C was added thereto to be a final concentration of 49.2 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 4) was thereby obtained.

### (Worked Product 5)

Compounding was performed using 700 ml of a mixture liquid of the green tea leaves extracted liquids A and B (compounding ratio (weight ratio) of green tea leaves extracted liquid A:green tea leaves extracted liquid B was 15:85) and the crushed tea leaves turbid liquid D in a similar manner to that for Worked Product 3 so that a target degree of transparency would be 6.0, and vitamin C was added thereto to be a final concentration of 22.3 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 5) was thereby obtained.

### (Worked Product 6)

Compounding was performed using 700 ml of a mixture liquid of the green tea leaves extracted liquids A and B (compounding ratio (weight ratio) of green tea leaves extracted liquid A:green tea leaves extracted liquid B was 6:94) and the crushed tea leaves turbid liquid D in a similar manner to that for Worked Product 3 so that a target degree of transparency would be 6.0, and vitamin C was added thereto to be a final concentration of 30.2 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 6) was thereby obtained.

### (Worked Product 7)

Compounding was performed using 700 ml of a mixture liquid of the green tea leaves extracted liquids A and B (compounding ratio (weight ratio) of green tea leaves extracted liquid A:green tea leaves extracted liquid B was 6:94) and the crushed tea leaves turbid liquid D in a similar manner to that for Worked Product 3 so that a target degree of transparency would be 9.0, and vitamin C was added thereto to be a final concentration of 40.0 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 7) was thereby obtained.

### (Worked Product 8)

Compounding was performed using 700 ml of a mixture liquid of the green tea leaves extracted liquids A and B (compounding ratio (weight ratio) of green tea leaves extracted liquid A:green tea leaves extracted liquid B was 6:94) and the crushed tea leaves turbid liquid D in a similar manner to that for Worked Product 3 so that a target degree of transparency would be 4.0, and vitamin C was added thereto to be a final concentration of 37.2 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 8) was thereby obtained.

### (Worked Product 9)

Compounding was performed using 700 ml of a mixture liquid of the green tea leaves extracted liquids A and B (compounding ratio (weight ratio) of green tea leaves extracted liquid A:green tea leaves extracted liquid B was 35:65) and the crushed tea leaves turbid liquid B in a similar manner to that for Worked Product 3 so that a target degree of transparency would be 6.0, and vitamin C was added thereto to be a final concentration of 28.8 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 9) was thereby obtained.

### (Worked Product 10)

Compounding was performed using 700 ml of a mixture liquid of the green tea leaves extracted liquids A and B (compounding ratio (weight ratio) of green tea leaves extracted liquid A:green tea leaves extracted liquid B was 2:98) and the crushed tea leaves turbid liquid B in a similar manner to that for Worked Product 3 so that a target degree of transparency would be 6.0, and vitamin C was added thereto to be a final concentration of 30.1 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 10) was thereby obtained.

### (Comparative Product 1)

Compounding was performed using 700 ml of a mixture liquid of the green tea leaves extracted liquids A and B (compounding ratio (weight ratio) of green tea leaves extracted liquid A:green tea leaves extracted liquid B was 50:50) and the crushed tea leaves turbid liquid C in a similar manner to that for Worked Product 3 so that a target degree of transparency would be 6.0, and vitamin C was added thereto to be a final concentration of 33.3 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 1) was thereby obtained.

### (Comparative Product 2)

Compounding was performed using 700 ml of a mixture liquid of the green tea leaves extracted liquids A and B (compounding ratio (weight ratio) of green tea leaves extracted liquid A:green tea leaves extracted liquid B was 0:100) and the crushed tea leaves turbid liquid C in a similar manner to that for Worked Product 3 so that a target degree of transparency would be 6.0, and vitamin C was added thereto to be a final concentration of 65.4 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 2) was thereby obtained.

### (Comparative Product 3)

Compounding was performed using 700 ml of a mixture liquid of the green tea leaves extracted liquids A and B (compounding ratio (weight ratio) of green tea leaves extracted liquid A:green tea leaves extracted liquid B was 48:52) and the crushed tea leaves turbid liquid E in a similar manner to that for Worked Product 3 so that a target degree of transparency would be 6.0, and vitamin C was added thereto to be a final concentration of 20.2 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 3) was thereby obtained.

### (Comparative Product 4)

Compounding was performed using 700 ml of a mixture liquid of the green tea leaves extracted liquids A and B (compounding ratio (weight ratio) of green tea leaves extracted liquid A:green tea leaves extracted liquid B was 1:99) and the crushed tea leaves turbid liquid E in a similar manner to that for Worked Product 3 so that a target degree of transparency would be 6.0, and vitamin C was added thereto to be a final concentration of 60 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 4) was thereby obtained.

### (Comparative Product 5)

Compounding was performed using 700 ml of a mixture liquid of the green tea leaves extracted liquids A and B (compounding ratio (weight ratio) of green tea leaves extracted liquid A:green tea leaves extracted liquid B was 38:62) and the crushed tea leaves turbid liquid F in a similar manner to that for Worked Product 3 so that a target degree of transparency would be 20.0, and vitamin C was added thereto to be a final concentration of 39.8 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 5) was thereby obtained.

### (Comparative Product 6)

Compounding was performed using 700 ml of a mixture liquid of the green tea leaves extracted liquids A and B (compounding ratio (weight ratio) of green tea leaves extracted liquid A:green tea leaves extracted liquid B was 3:97) and the crushed tea leaves turbid liquid F in a similar manner to that for Worked Product 3 so that a target degree of transparency would be 20.0, and vitamin C was added thereto to be a final concentration of 42.7 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 6) was thereby obtained.

### (Comparative Product 7)

Compounding was performed using 700 ml of a mixture liquid of the green tea leaves extracted liquids A and B (compounding ratio (weight ratio) of green tea leaves extracted liquid A:green tea leaves extracted liquid B was 2:98) and the crushed tea leaves turbid liquid A in a similar manner to that for Worked Product 3 so that a target degree of transparency would be 9.0, and vitamin C was added thereto to be a final concentration of 52.2 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 7) was thereby obtained.

### (Comparative Product 8)

Compounding was performed using 700 ml of a mixture liquid of the green tea leaves extracted liquids A and B (compounding ratio (weight ratio) of green tea leaves extracted liquid A:green tea leaves extracted liquid B was 5:95) and 489 ml of a mixture liquid of the crushed tea leaves turbid liquids A and B (326 ml of the crushed tea leaves turbid liquid A and 163 ml of the crushed tea leaves turbid liquid B were mixed) (compounding was performed using the compounding amounts of the mixture liquid of the green tea leaves extracted liquids A and B and the mixture liquid of the crushed tea leaves turbid liquids A and B so that a target degree of transparency would be 6.0), and vitamin C was added thereto to be a final concentration of 32.2 mg %. Sodium bicarbonate was added to the obtained mixture liquid to adjust the pH, and the liquid was then diluted with pure water to 2000 mL using a measuring cylinder. Subsequently, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 8) was thereby obtained.

### (Evaluation Method)

For all of Worked Products 1 to 10 and Comparative Products 1 to 8, ten persons of skilled panelists performed sensory evaluation immediately after opening (5° C.) (Sensory Evaluation 1), sensory evaluation when 1 hour elapsed after opening (20° C. stationary placement) (Sensory Evaluation 2), and sensory evaluation when 4 hours elapsed after opening (20° C. stationary placement) (Sensory Evaluation 3). Four-grade evaluation (1-point to 4-point) was performed and an average was calculated for each sample to classify the sample into “⊚” (4-point), “◯” (3-point), “Δ” (2-point) and “X” (1-point) in order from excellent evaluation. Evaluation items in each sensory evaluation were the aroma felt in the mouth, lingering taste, thickness, deliciousness and feeling in the throat.

In addition, for all of Worked Products 1 to 10 and Comparative Products 1 to 8, the appearance of each sample after stationary placement at 20° C. for 1 month was evaluated in a similar manner to the above.

Furthermore, the “comprehensive evaluation” was performed by evaluating the suitability for a product of each green tea beverage packed in a container, including the aroma felt in the mouth, lingering taste, thickness, deliciousness, feeling in the throat, appearance and the like, in a similar manner to the above.

Tables 1 to 4 show the compounding ratio (weight) in each of Worked Products 1 to 10 and Comparative Products 1 to 8, the measurement results of each component, and the evaluation results of each sample.

TABLE 1

| | Worked | Worked | Worked | Worked | Worked |
|---|---|---|---|---|---|
| | Product 1 | Product 2 | Product 3 | Product 4 | Product 5 |
| Green tea | 38 | 3 | 31 | 5 | 15 |
| leaves | | | | | |
| extracted | | | | | |
| liquid A | | | | | |
| Green tea | 62 | 97 | 69 | 95 | 85 |
| leaves | | | | | |
| extracted | | | | | |
| liquid B | | | | | |
| Crushed tea | A + D | A + F | E | E | D |
| leaves turbid | | | | | |
| liquid used | | | | | |
| | Worked | Worked | Worked | Worked | Worked |
| | Product 6 | Product 7 | Product 8 | Product 9 | Product 10 |
| Green tea | 6 | 6 | 6 | 35 | 2 |
| leaves | | | | | |
| extracted | | | | | |
| liquid A | | | | | |
| Green tea | 94 | 94 | 94 | 65 | 98 |
| leaves | | | | | |
| extracted | | | | | |
| liquid B | | | | | |
| Crushed tea | D | D | D | B | B |
| leaves turbid | | | | | |
| liquid used | | | | | |

TABLE 2

| | Comparative | Comparative | Comparative | Comparative |
|---|---|---|---|---|
| | Product 1 | Product 2 | Product 3 | Product 4 |
| Green tea | 50 | 0 | 48 | 1 |
| leaves | | | | |
| extracted | | | | |
| liquid A | | | | |
| Green tea | 50 | 100 | 52 | 99 |
| leaves | | | | |
| extracted | | | | |
| liquid B | | | | |
| Crushed tea | C | C | E | E |
| leaves turbid | | | | |
| liquid used | | | | |
| | Comparative | Comparative | Comparative | Comparative |
| | Product 5 | Product 6 | Product 7 | Product 8 |
| Green tea | 38 | 3 | 2 | 5 |
| leaves | | | | |
| extracted | | | | |
| liquid A | | | | |
| Green tea | 62 | 97 | 98 | 95 |
| leaves | | | | |
| extracted | | | | |
| liquid B | | | | |
| Crushed tea | F | F | A | A + B |
| leaves turbid | | | | |
| liquid used | | | | |

TABLE 3

| | Worked | | | | | | | | | |
|---|---|---|---|---|---|---|---|---|---|---|
| | product | Worked | Worked | Worked | Worked | Worked | Worked | Worked | Worked | Worked |
| | 1 | product 2 | product 3 | product 4 | product 5 | product 6 | product 7 | product 8 | product 9 | product 10 |
| Particle size | 42.3 | 39.1 | 4.2 | 4.3 | 28.2 | 27.5 | 27.3 | 27.1 | 57.2 | 55 |
| distribution (D90) | | | | | | | | | | |
| Sugar/tartness | 0.389 | 0.132 | 0.333 | 0.153 | 0.26 | 0.179 | 0.169 | 0.171 | 0.377 | 0.143 |
| degree ratio | | | | | | | | | | |
| Degree of | 5.4 | 11.8 | 6.4 | 6 | 5.8 | 6.2 | 8.6 | 4.4 | 6 | 6.2 |
| transparency | | | | | | | | | | |
| Disaccharide (ppm) | 222 | 83 | 194 | 91 | 131 | 95 | 94 | 95 | 210 | 79 |
| Monosaccharide + | 320 | 94 | 274 | 107 | 172 | 113 | 111 | 114 | 300 | 87 |
| disaccharide (ppm) | | | | | | | | | | |
| Disaccharide/ | 0.69 | 0.88 | 0.71 | 0.85 | 0.76 | 0.84 | 0.85 | 0.83 | 0.7 | 0.91 |
| (monosaccharide + | | | | | | | | | | |
| disaccharide) | | | | | | | | | | |
| Tannin (mg %) | 71 | 51 | 67 | 52 | 58 | 52 | 51 | 53 | 69 | 50 |
| Catechins (mg %) | 56 | 33 | 51 | 34 | 41 | 35 | 34 | 36 | 54 | 32 |
| Electron-localized | 50 | 30 | 46 | 31 | 37 | 32 | 31 | 33 | 49 | 29 |
| catechins (mg %) | | | | | | | | | | |
| Electron-localized | 1.6 | 3.2 | 1.7 | 2.9 | 2.2 | 2.8 | 2.8 | 2.9 | 1.6 | 3.3 |
| catechins/sugars | | | | | | | | | | |
| Caffeine | 15 | 12 | 15 | 12 | 13 | 13 | 12 | 14 | 15 | 12 |
| Vitamin C (mg %) | 31.1 | 55.5 | 42.2 | 49.2 | 22.3 | 30.2 | 40 | 37.2 | 28.8 | 30.1 |
| Bx | 0.34 | 0.28 | 0.33 | 0.29 | 0.31 | 0.29 | 0.28 | 0.31 | 0.34 | 0.28 |
| pH | 6.2 | 6.2 | 6.3 | 6.3 | 6.4 | 6.2 | 6.3 | 6.2 | 6.2 | 6 |

Evaluation immediately after opening (5° C.)

| | | | | | | | | | | |
|---|---|---|---|---|---|---|---|---|---|---|
| Aroma felt in the | Δ | ◯ | Δ | ◯ | Δ | ◯ | ◯ | Δ | Δ | ◯ |
| mouth | | | | | | | | | | |
| Lingering taste | ◯ | Δ | ◯ | Δ | ◯ | Δ | Δ | Δ | ◯ | Δ |
| Thickness | ◯ | Δ | Δ | Δ | ◯ | ◯ | Δ | ◯ | ⊚ | ⊚ |
| Deliciousness | ◯ | ◯ | ⊚ | ⊚ | ⊚ | ⊚ | ⊚ | ◯ | Δ | Δ |
| Feeling in the throat | ◯ | Δ | Δ | Δ | ◯ | ◯ | Δ | ⊚ | ⊚ | ⊚ |

Evaluation when 1 hour elapsed after opening (20° C.)

| | | | | | | | | | | |
|---|---|---|---|---|---|---|---|---|---|---|
| Aroma felt in the | ◯ | ⊚ | ◯ | ⊚ | ◯ | ⊚ | ⊚ | ◯ | ◯ | ⊚ |
| mouth | | | | | | | | | | |
| Lingering taste | ⊚ | ◯ | ⊚ | ◯ | ⊚ | ◯ | ◯ | ◯ | ⊚ | ◯ |
| Thickness | ⊚ | ◯ | ◯ | ◯ | ⊚ | ⊚ | ◯ | ⊚ | ⊚ | ⊚ |
| Deliciousness | Δ | Δ | ⊚ | ◯ | ⊚ | ⊚ | ⊚ | Δ | Δ | Δ |
| Feeling in the throat | ⊚ | ◯ | ◯ | ◯ | ⊚ | ⊚ | ◯ | ⊚ | ◯ | ◯ |

Evaluation when 4 hours elapsed after opening (20° C.)

| | | | | | | | | | | |
|---|---|---|---|---|---|---|---|---|---|---|
| Aroma felt in the | ◯ | ⊚ | ◯ | ⊚ | ◯ | ⊚ | ⊚ | ◯ | ◯ | ⊚ |
| mouth | | | | | | | | | | |
| Lingering taste | ⊚ | ◯ | ⊚ | ◯ | ⊚ | ◯ | ◯ | ◯ | ⊚ | ◯ |
| Thickness | ⊚ | ◯ | ◯ | ◯ | ⊚ | ⊚ | ◯ | ⊚ | ⊚ | ⊚ |
| Deliciousness | Δ | Δ | ⊚ | ◯ | ⊚ | ⊚ | ⊚ | Δ | Δ | Δ |
| Feeling in the throat | ⊚ | Δ | ◯ | ◯ | ⊚ | ⊚ | ◯ | ◯ | Δ | Δ |
| Temporal evaluation | Δ | Δ | ⊚ | ⊚ | ◯ | ◯ | ⊚ | Δ | Δ | Δ |
| (appearance) | | | | | | | | | | |
| Comprehensive | ◯ | ◯ | ◯ | ◯ | ⊚ | ⊚ | ◯ | ◯ | ◯ | ◯ |
| evaluation | | | | | | | | | | |

TABLE 4

| | Comparative | Comparative | Comparative | Comparative | Comparative | Comparative | Comparative | Comparative |
|---|---|---|---|---|---|---|---|---|
| | product 1 | product 2 | product 3 | product 4 | product 5 | product 6 | product 7 | product 8 |
| Particle size | 38.4 | 36.6 | 4 | 3.2 | 1.8 | 1.7 | 78 | 67.7 |
| distribution (D90) | | | | | | | | |
| Sugar/tartness degree | 0.441 | 0.103 | 0.456 | 0.114 | 0.35 | 0.137 | 0.128 | 0.174 |
| ratio | | | | | | | | |
| Degree of | 6 | 5.6 | 5.8 | 5.6 | 20 | 18.6 | 9.4 | 4.4 |
| transparency | | | | | | | | |
| Disaccharide (ppm) | 270 | 72 | 262 | 76 | 200 | 81 | 79 | 93 |
| Monosaccharide + | 398 | 75 | 385 | 82 | 296 | 90 | 87 | 111 |
| disaccharide (ppm) | | | | | | | | |
| Disaccharide/ | 0.68 | 0.96 | 0.68 | 0.93 | 0.68 | 0.9 | 0.91 | 0.84 |
| (monosaccharide + | | | | | | | | |
| disaccharide) | | | | | | | | |
| Tannin (mg %) | 78 | 49 | 77 | 50 | 70 | 50 | 49 | 52 |
| Catechins (mg %) | 64 | 31 | 62 | 32 | 54 | 32 | 31 | 34 |
| Electron-localized | 58 | 28 | 56 | 29 | 49 | 29 | 28 | 31 |
| catechins (mg %) | | | | | | | | |
| Electron-localized | 1.5 | 3.7 | 1.5 | 3.5 | 1.7 | 3.2 | 3.2 | 2.8 |
| catechins/sugars | | | | | | | | |
| Caffeine | 17 | 12 | 16 | 12 | 14 | 11 | 11 | 12 |
| Vitamin C (mg %) | 33.3 | 65.4 | 20.2 | 60 | 39.8 | 42.7 | 52.2 | 32.2 |
| Bx | 0.37 | 0.28 | 0.36 | 0.28 | 0.33 | 0.27 | 0.27 | 0.29 |
| pH | 6.1 | 6 | 6.2 | 6.1 | 6.1 | 6.2 | 6.1 | 6.2 |

Evaluation immediately after opening (5° C.)

| | | | | | | | | |
|---|---|---|---|---|---|---|---|---|
| Aroma felt in the | X | ◯ | X | ◯ | Δ | ◯ | ◯ | X |
| mouth | | | | | | | | |
| Lingering taste | ◯ | X | ◯ | X | ◯ | Δ | Δ | X |
| Thickness | ◯ | ◯ | Δ | Δ | X | X | ◯ | ⊚ |
| Deliciousness | Δ | Δ | ◯ | ◯ | ◯ | ◯ | ◯ | ◯ |
| Feeling in the throat | ◯ | ◯ | Δ | Δ | X | X | ◯ | Δ |

Evaluation when 1 hour elapsed after opening (20° C.)

| | | | | | | | | |
|---|---|---|---|---|---|---|---|---|
| Aroma felt in the | X | ⊚ | X | ⊚ | ◯ | ⊚ | ⊚ | Δ |
| mouth | | | | | | | | |
| Lingering taste | ⊚ | X | ⊚ | X | ⊚ | ◯ | ◯ | Δ |
| Thickness | ⊚ | ⊚ | ◯ | ◯ | Δ | Δ | ⊚ | ⊚ |
| Deliciousness | X | X | Δ | Δ | Δ | ◯ | Δ | Δ |
| Feeling in the throat | ⊚ | ⊚ | ◯ | ◯ | Δ | Δ | Δ | X |

Evaluation when 4 hours elapsed after opening (20° C.)

| | | | | | | | | |
|---|---|---|---|---|---|---|---|---|
| Aroma felt in the | X | ⊚ | X | ⊚ | ◯ | ⊚ | ⊚ | Δ |
| mouth | | | | | | | | |
| Lingering taste | ⊚ | X | ⊚ | X | ⊚ | ◯ | ◯ | Δ |
| Thickness | ⊚ | ⊚ | ◯ | ◯ | Δ | Δ | ⊚ | ⊚ |
| Deliciousness | X | X | Δ | Δ | Δ | ◯ | X | X |
| Feeling in the throat | ◯ | ◯ | ◯ | ◯ | Δ | Δ | X | X |
| Temporal evaluation | Δ | Δ | ⊚ | ⊚ | ⊚ | ⊚ | Δ | X |
| (appearance) | | | | | | | | |
| Comprehensive | Δ | Δ | Δ | Δ | Δ | Δ | Δ | Δ |
| evaluation | | | | | | | | |

### DISCUSSION

With regard to Worked Products 1 to 10 according to the present invention, the evaluation immediately after opening and the evaluations when 1 hour and 4 hours elapsed after opening were relatively good or very good for many items of the aroma felt in the mouth, lingering taste, thickness and deliciousness. Highly balanced products were thus able to be obtained each offering good or very good comprehensive evaluation from the viewpoint that the balance of the aroma felt in the mouth, lingering taste, thickness and deliciousness was excellent and the appearance was also excellent with regard to the temporal evaluation.

In contrast, each of Comparative Products 1 to 8 exhibited insufficient balance, such as that the aroma felt in the mouth and the deliciousness were insufficient (Comparative Products 1, 3, 7 and 8), the lingering taste was seriously insufficient (Comparative Products 2 and 4), the feeling in the throat was seriously insufficient (Comparative Products 7 and 8), and the thickness and the feeling in the throat were generally insufficient. The comprehensive evaluation was thus not good in Comparative Products 1 to 8.

1. A green tea beverage packed in a container wherein:
a particle diameter of cumulative 90 mass % in a tea extracted liquid is 3 μm to 60 μm; and
a sugar/tartness degree ratio is 0.12 to 0.43.

2. The green tea beverage packed in a container as recited in claim 1, wherein a concentration of sugars, which is a sum of a concentration of monosaccharide and a concentration of disaccharide, is 87 ppm to 380 ppm.

3. The green tea beverage packed in a container as recited in claim 1, wherein a weight ratio of a concentration of disaccharide to a concentration of sugars, which is a sum of a concentration of monosaccharide and the concentration of disaccharide, is 0.69 to 0.92.

4. The green tea beverage packed in a container as recited in claim 1, wherein a total value of a tartness degree is 600 ppm to 840 ppm.

5. The green tea beverage packed in a container as recited in claim 1, wherein a concentration of electron-localized catechin is 250 ppm to 550 ppm.

6. The green tea beverage packed in a container as recited in claim 1, wherein a concentration of caffeine is less than 200 ppm.

7. The green tea beverage packed in a container as recited in claim 1, wherein the green tea beverage contains particles having an average particle diameter of 1 μm or more.

8. The green tea beverage packed in a container as recited in claim 1, wherein a degree of transparency is 4 to 12.

9. A method of manufacturing a green tea beverage packed in a container, the method comprising:
adjusting a particle diameter of cumulative 90 mass % in a tea extracted liquid to 3 μm to 60 μm; and
adjusting a sugar/tartness degree ratio to 0.12 to 0.43.

10. A method of improving a taste of a green tea beverage, the method comprising:
adjusting a particle diameter of cumulative 90 mass % in a tea extracted liquid to 3 μm to 60 μm; and
adjusting a sugar/tartness degree ratio to 0.12 to 0.43.
